(19) United States
(12) Patent Application Publication
(10) Pub. No.: US 2006/0070000 A1
(43) Pub. Date: Mar. 30, 2006

(54) Image display device and control method of the same

(75) Inventor: Tatsuya Ichikawa, Nagano-Ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/229,584

(22) Filed: Sep. 20, 2005

(30) Foreign Application Priority Data
Sep. 22, 2004 (JP) 2004-275665
Mar. 25, 2005 (JP) 2005-088639

(51) Int. Cl. G06F 17/00

(52) U.S. Cl. 715/730

(57) ABSTRACT

An image display device disclosed herein includes an image data storage in which plural image data are stored; a slide show displayer which performs a slide show display in which the image data are sequentially read from the image data storage and the image data are continuously displayed according to previously set slide show setting information; a temporary stopper which temporarily stops the slide show display of the image data by the slide show displayer based on an instruction from a user; an image data specifying information storage which stores image data specifying information which specifies image data displayed when the slide show display of the image data is temporarily stopped by the temporary stopper; and a slide show restarter which reads the image data specifying information from the image data specifying information storage and restarts the slide show display from the image data specified by the image data specifying information.

### CROSS REFERENCE TO RELATED APPLICATION

This application claims benefit of priority under 35 u.s.c.§119 to Japanese patent application No. 2004-275665, filed on Sep. 22, 2004, and No. 2005-88639, filed on Mar. 25, 2005, the entire contents of which are incorporated by reference herein.

### BACKGROUND OF THE INVENTION

1. Field of the Invention

The present invention relates to an image display device and a control method of the same, and particularly relates to an image display device which realizes an improvement in user-friendliness when image data are displayed in a slide show and a control method of the same.

2. Related Background Art

With the prevalence of digital cameras, the chances for individual users to take pictures with a digital camera and generate image data as digital data are increasing. The image data taken by the digital camera can be incorporated and stored in an image display device such as a personal computer, a photo viewer, or the like using a memory card or using a USB cable.

The image data stored in the image display device can be continuously displayed in a slide show, for example, as disclosed in Japanese Patent Application Laid-open No. 2003-309815. Namely, the image data can be continuously displayed by automatic switching at set time intervals. Moreover, some image display devices can play BGM along with the display of the image data. Further, when switching image display from one image to the next, some image display devices can erase the displayed image in such a manner as to lower a blind and display the next image in such a manner as to raise the blind, thereby enabling effective image switching. Various settings of the slide show such as these image switching time interval, effect, and BGM can be set from a setting screen by the user at the user's discretion.

However, a conventional slide show has a problem that if one of the various settings of the slide show is changed after the slide show is started, the slide show is started from the first image data, whereby if there are many image data in the slide show, it is not easy to watch the slide show to the last. There is another problem that if many image data are watched with the same BGM, the user tends to lose interest in images.

### SUMMARY OF THE INVENTION

Hence, the present invention is made in view of the aforementioned problems, and an object of the present invention is to provide an image display device which realizes an improvement in user-friendliness when image data are displayed in a slide show and a control method of the same.

In order to accomplish the aforementioned and other objects, according to one aspect of the present invention, an image display device, comprises:

an image data storage in which plural image data are stored;

a slide show displayer which performs a slide show display in which the image data are sequentially read from the image data storage and the image data are continuously displayed according to previously set slide show setting information;

a temporary stopper which temporarily stops the slide show display of the image data by the slide show displayer based on an instruction from a user;

an image data specifying information storage which stores image data specifying information which specifies image data displayed when the slide show display of the image data is temporarily stopped by the temporary stopper; and

a slide show restarter which reads the image data specifying information from the image data specifying information storage and restarts the slide show display from the image data specified by the image data specifying information.

According to another aspect of the present invention, a control method of an image display device including an image data storage in which plural image data are stored, comprises the steps of:

performing a slide show display in which the image data are sequentially read from the image data storage and the image data are continuously displayed according to previously set slide show setting information;

temporarily stopping the slide show display based on an instruction from a user;

storing image data specifying information which specifies image data displayed when the slide show display is temporarily stopped; and

restarting the slide show display from the image data specified by the stored image data specifying information.

According to another aspect of the present invention, a recording medium comprises a program to control an image display device including an image data storage in which plural image data are stored, the program is recorded on the recording medium, wherein the program causes the image display device to execute the steps of:

performing a slide show display in which the image data are sequentially read from the image data storage and the image data are continuously displayed according to previously set slide show setting information;

temporarily stopping the slide show display based on an instruction from a user;

storing image data specifying information which specifies image data displayed when the slide show display is temporarily stopped; and

restarting the slide show display from the image data specified by the stored image data specifying information.

### BRIEF DESCRIPTION OF THE DRAWINGS

FIG. 1 is a diagram showing the internal configuration of an image display device according to a first embodiment;

FIG. 2 is a diagram showing an example of the configuration of image data in a folder according to the first embodiment;

FIG. 3 is a diagram showing an example of a plane layout of the image display device on the side of a display screen;

FIG. 4 is a flowchart showing an example of a slide show execution process executed by the image display device according to the first embodiment (PART 1);

FIG. 5 is a flowchart showing the example of the slide show execution process executed by the image display device according to the first embodiment (PART 2);

FIG. 6 is a diagram showing an example of the structure of a display order table according to the first embodiment;

FIG. 7 is a diagram showing an example of the display order of image data according to the first embodiment;

FIG. 8 is a diagram showing an example of the configuration of picture image storage regions formed in a RAM according to the first embodiment;

FIG. 9 is a diagram showing an example of the structure of a slide show setting information table according to the first embodiment;

FIG. 10 is a diagram showing an example of a slide show setting change menu displayed in the display screen of the image display device according to the first embodiment;

FIG. 11 is a flowchart showing an example of a slide show execution process executed by an image display device according to a second embodiment (PART 1);

FIG. 12 is a flowchart showing the example of the slide show execution process executed by the image display device according to the second embodiment (PART 2);

FIG. 13 is a diagram showing an example of the configuration of image data in a folder according to the second embodiment;

FIG. 14 is a diagram showing an example of the structure of a setting history file according to the second embodiment;

FIG. 15 is a flowchart showing an example of a slide show execution process executed by an image display device according to a third embodiment (PART 1);

FIG. 16 is a flowchart showing the example of the slide show execution process executed by the image display device according to the third embodiment (PART 2);

FIG. 17 is a diagram showing an example of the structure of a setting history file according to the third embodiment;

FIG. 18 is a diagram showing an example of a setting selection screen displayed in the image display device according to the third embodiment; and

FIG. 19 is a diagram showing additional parts of the internal configuration of an image display device in a case where the slide show execution process is implemented by the hardware.

### DETAILED DESCRIPTION OF THE EMBODIMENTS

### First Embodiment

An image display device according to this embodiment is designed in such a manner as to, even while a slide show display is being executed, temporarily stop the slide show display, allow a user to change various settings on the slide show display during the stop, and after the changed various settings are enabled, to restart the slide show display from temporarily stopped image data. Further details will be given below.

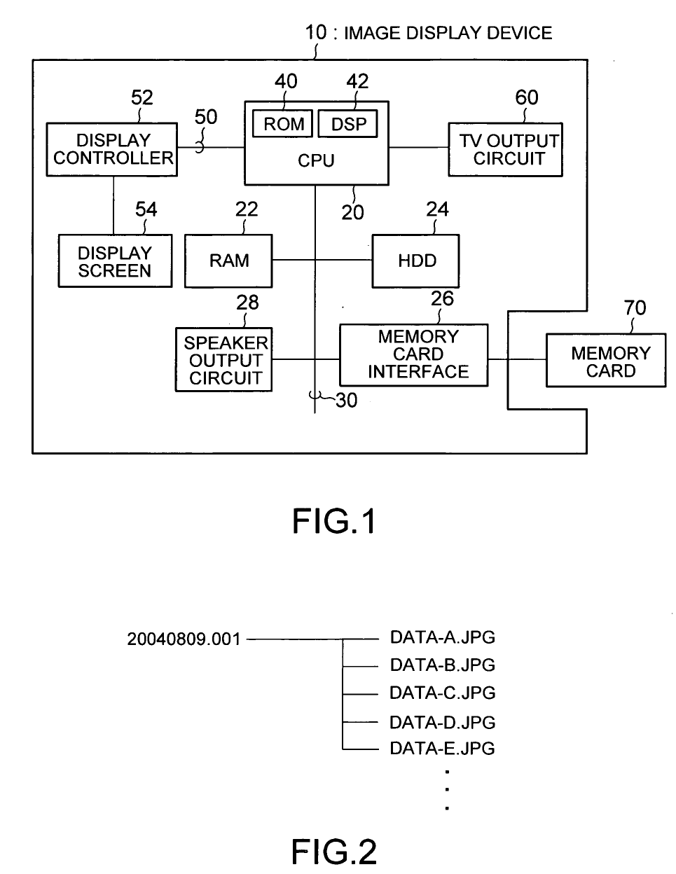

FIG. 1 is a block diagram for explaining the internal configuration of an image display device 10 according to this embodiment. As shown in FIG. 1, the image display device 10 according to this embodiment includes a CPU (Central Processing Unit) 20, a RAM (Random Access Memory) 22, a hard disk drive 24, a memory card interface 26, and a speaker output circuit 28, and they are interconnected via an internal bus 30. The speaker output circuit 28 is a circuit to output music and voice, and particularly in this embodiment has a function of playing BGM in the slide show.

A ROM (Read Only Memory) 40 and a DSP (Digital Signal Processor) 42 are contained in the CPU 20. The DSP 42 performs processes of compressing image data and expanding compressed image data.

Further, the CPU 20, is connected to a display controller 52 via a dedicated bus 50, and this display controller 52 is connected to a display screen 54. Namely, when the CPU 20 transmits image data to be displayed to the display controller 52 via the dedicated bus 50, the display controller 52 controls the display screen 54 based on the image data, and displays the image data on the display screen 54. Incidentally, in this embodiment, the display screen 54 is composed of an LCD.

The image display device 10 according to this embodiment further includes a TV output circuit 60. Therefore, the user can watch images outputted by the CPU 20 on home television if a TV image output cable is connected to a connector (not shown) of the image display device 10.

A memory card 70 is attached to this image display device 10 as necessary. Image data stored on the memory card 70 attached to the image display device 10 can be captured by the image display device 10 via the memory card interface 26. More specifically, the image data stored in the memory card 70 are captured by the CPU 20 via the memory card interface 26 and stored in the hard disk drive 24.

In this embodiment, the image display device 10 is assumed to be a photo viewer which is a portable storage device, but the image display device 10 can be composed of an ordinary personal computer or a notebook personal computer.

FIG. 2 is a diagram showing an example of a folder structure of a region where image data are stored in the hard disk drive 24 of the image display device 10 according to this embodiment. In the example shown in FIG. 2, under a folder “20040809.001”, image data “DATA-A.JPG”, “DATA-B.JPG”, “DATA-C.JPG”, “DATA-D,JPG” . . . are stored.

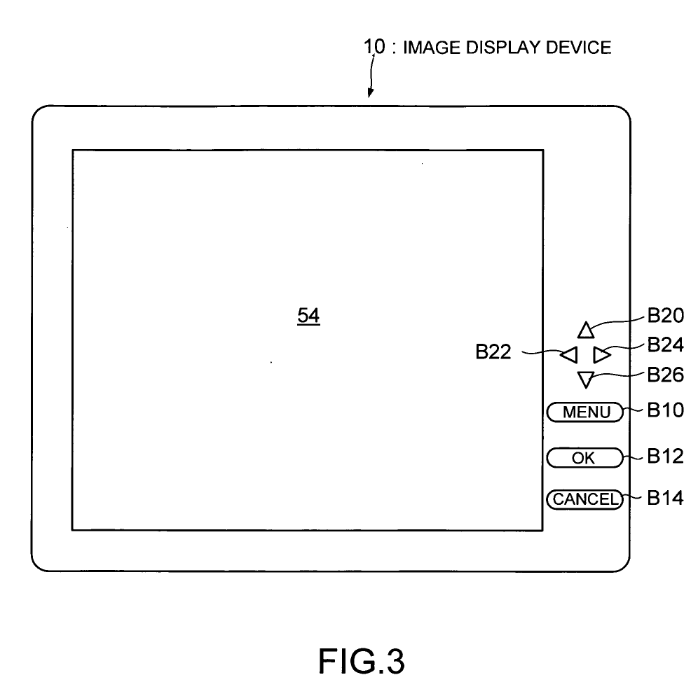

FIG. 3 is a plan view of the image display device 10 according to this embodiment when viewed from the display screen 54 side. As shown in FIG. 3, on the right side of the display screen 54, a menu button B10, an OK button B12, and a cancel button B14 which are operated by the user's finger are provided. Further, an upward movement button B20, a leftward movement button B22, a rightward movement button B24, and a downward movement button B26 are provided thereon.

The menu button B10 is an operation button to display various kinds of menu screens on the display screen 54. The OK button B12 is an operation button which is pressed in a case where, when various settings are performed on the menu screen, the contents of change are finally decided. The cancel button B14 is an operation button which is pressed in a case where, when various setting are performed on the menu screen, the contents of change are not finally reflected. The upward movement button B20, the leftward movement button B22, the rightward movement button B24, and the downward movement button B26 are operation buttons to move a pointing cursor upward, leftward, rightward, and downward, respectively on the menu screen.

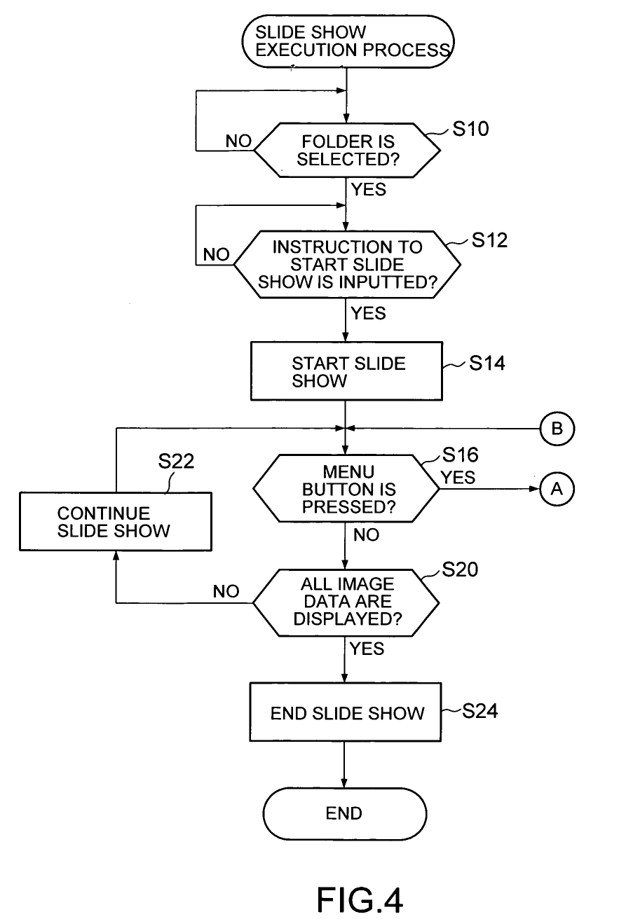

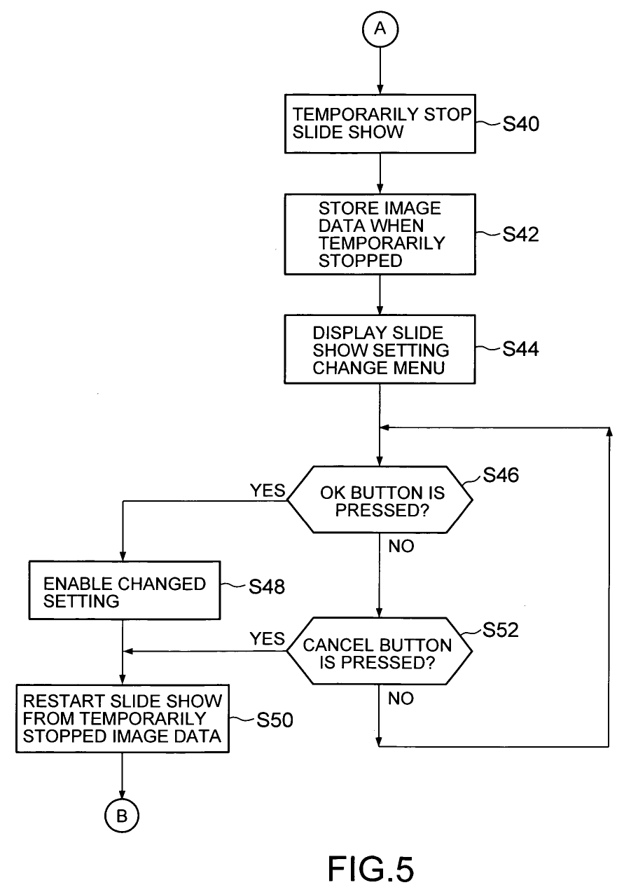

FIG. 4 and FIG. 5 are flowcharts describing a slide show execution process executed by the image display device 10 according to this embodiment. This slide show execution process is realized by making the CPU 20 read and execute a slide show execution program stored in the ROM 40. The slide show execution process is started by the user operating the menu button B10, the OK button B12, the movement buttons B20, B22, B24, and B26 to instruct the image display device 10 to execute a slide show.

First, as shown in FIG. 4, the image display device 10 judges whether a folder in which image data to be displayed in the slide show are stored is selected by the user (step S10). Namely, the user operates the menu button B10, the OK button B12, the cancel button B14, and the movement buttons B20, B22, B24, and B26 to specify the folder in which the image data to be displayed in the slide show are stored. When the folder is not selected by the user (step S10: NO), the image display device 10 stands by while repeating the process in step S10. In the following description, it is assumed that the folder “20040809.001” shown in FIG. 2 is specified.

On the other hand, when the folder is selected by the user (step S10: YES), the image display device 10 judges whether an instruction to start the slide show is inputted by the user (step S12). Namely, the user operates the menu button B10, the OK button B12, the cancel button B14, and the movement buttons B20, B22, B24, and B26 to input the instruction to start the slide show to the image display device 10. When the instruction to start the slide show is not inputted by the user (step S12: NO), the image display device 10 stands by while repeating the process in step S12.

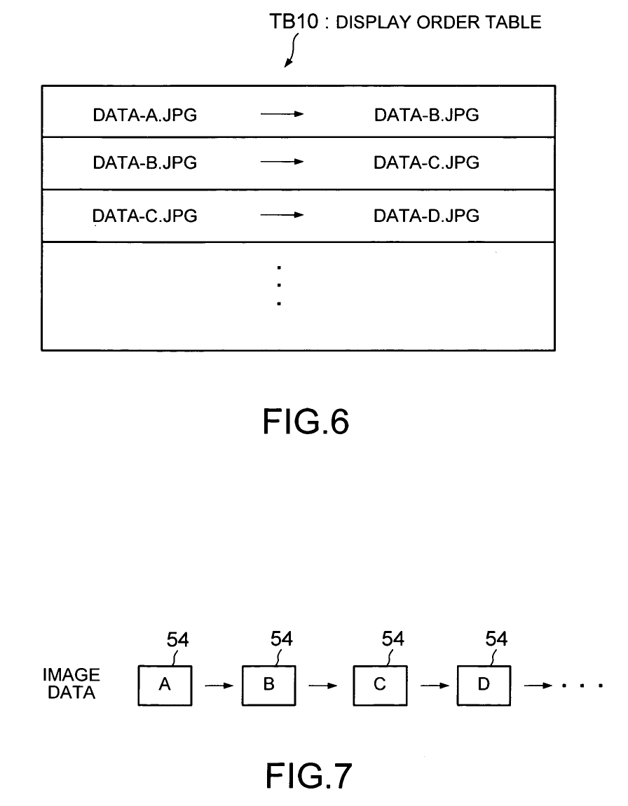

On the other hand, when the instruction to start the slide show is inputted by the user (step S12: YES), display of the image data in the slide show is started (step S14). FIG. 6 is a diagram showing an example of the structure of a display order table TB10 according to this embodiment. In this embodiment, this display order table TB10 is set at the user's discretion, and formed and stored in the RAM 22.

The example in FIG. 6 shows that next to the image data DATA-A.JPG, the image data DATA-B.JPG is displayed, next to the image data DATA-B.JPG, the image data DATA-C.JPG is displayed, and that next to the image data DATA-C.JPG, the image data DATA-D.JPG is displayed. Namely, in this embodiment, image data being displayed and image data displayed next are held in a one-to-one correspondence.

When the slide show is displayed based on the display order table TB10 in FIG. 6, image data are continuously read in sequence from the hard disk drive 24 in the order of image data such as shown in FIG. 7 and images are displayed on the display screen 54. Namely, an image A based on the image data DATA-A.JPG, an image B based on the image data DATA-B.JPG, an image C based on the image data DATA-C.JPG, an image data D based on the image data DATA-D.JPG, . . . are displayed on the display screen 54 in this order.

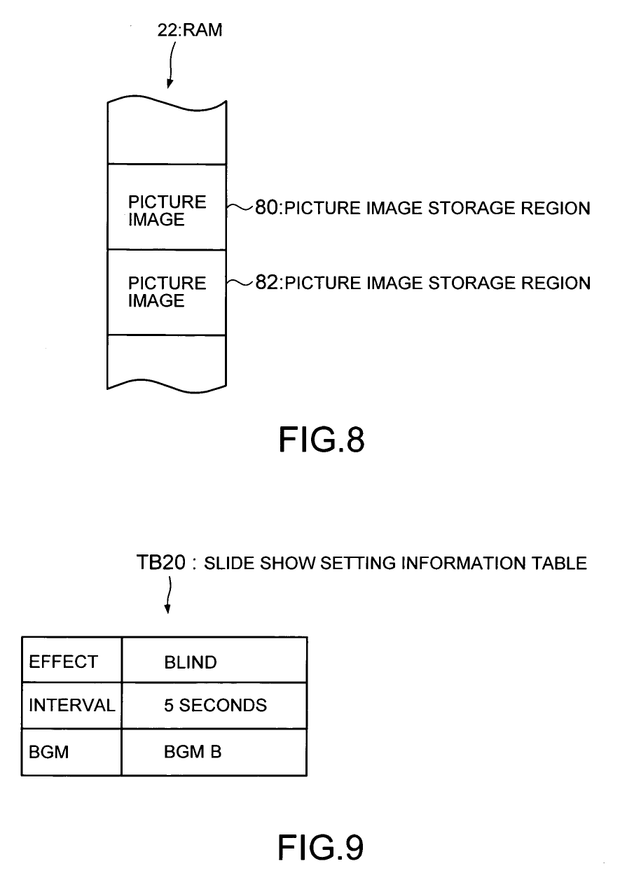

FIG. 8 is a diagram showing picture image storage regions 80 and 82 formed in the RAM 22. As can be seen from FIG. 8, in this embodiment, two picture image storage regions 80 and 82 are formed. The image display device 10 creates a picture image (the image A) based on DATA-A.JPG in the picture image storage region 80 and displays the created picture image on the display screen 54. While this image A of DATA-A.JPG is being displayed on the display screen 54, a picture image (the image B) based on DATA-B.JPG is created in the picture image storage region 82. When the display of the image A of DATA-A.JPG is switched to the display of the image B of DATA-B.JPG, it is only required to read the image data in the picture image storage region 82 as it is. Such a structure makes it possible to switch between images by erasing the image A in such a manner as to lower a blind and displaying the image B in such a manner as to raise the blind or by fade-in/fade-out in which the image A is gradually erased and the image B is gradually displayed.

FIG. 9 is a diagram showing an example of the structure of a slide show setting information table TB20 according to this embodiment. When displaying the slide show, the image display device 10 displays it based on slide show setting information of this slide show setting information table TB20. The example in FIG. 9 shows that the switching between images is performed by the aforementioned blind display method, the time interval of the switching between images is 5 seconds, and that “BGM B” is selected as BGM. In this embodiment, the CPU 20 reads a default slide show setting stored in the ROM 40 and stores it in the RAM 22, thereby creating the slide show setting information table TB20. Accordingly, in this embodiment, the contents of the slide show setting information table TB20 once set remains effective until the power is turned off.

Then, as shown in FIG. 4, the image display device 10 judges whether the menu button B10 is pressed while the slide show is being executed (step S16).

When the menu button B10 is not pressed (step S16: NO), the image display device 10 judges whether all the image data under the folder selected by the user are displayed in the slide show (step S18). When all the image data are not displayed (step S18: NO), the image display device 10 continues the slide show (step S22), and returns to step S16.

On the other hand, when all the image data under the folder selected by the user are displayed (step S18: YES), the image display device 10 ends the slide show (step S24), and this slide show execution process is completed.

In contrast, when it is judged in the aforementioned step S16 that the menu button B10 is pressed (step S16: YES), as shown in FIG. 5, the image display device 10 temporarily stops the slide show (step S40).

Then, the image display device 10 stores information which specifies on which image the slide show has been temporarily stopped (step S42). In this embodiment, this information is stored in the RAM 22. For example, assuming that the slide show has been temporarily stopped on the image B of the image data DATA-B.JPG, the image display device 10 stores information specifying the image B.

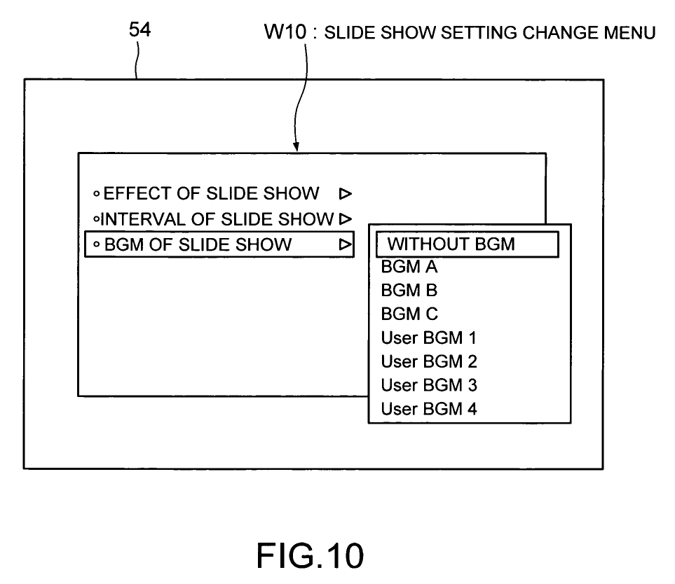

Thereafter, the image display device 10 displays a slide show setting change menu on the display screen 54 (step S44). FIG. 10 is a diagram showing an example of a slide show setting change menu W10 according to this embodiment. As shown in FIG. 10, in the slide show setting change menu W10, it is possible to change the setting of the effect of the slide show, the setting of the time interval of the slide show, and the setting of the BGM of the slide show.

By changing the setting of the effect of the slide show, for example, the display method when the screen switches can be changed from the method of switching in such a manner that the blind is lowered and raised to the method of switching in such a manner that the image gradually fades in/fades out to the next image. Further, by changing the setting of the time interval of the slide show, for example, switching to the next image at an interval of 5 seconds can be changed to switching to the next image at an interval of 10 seconds. Furthermore, by changing the setting of the BGM of the slide show, the use of “BGM B” as the BGM of the slide show can be changed to “WITHOUT BGM”. The example in FIG. 10 shows a state in which the user changes the setting of the BGM of the slide show to “WITHOUT BGM”.

Then, as shown in FIG. 5, the image display device 10 judges whether the OK button B12 is pressed (step S46). When the OK button B12 is pressed (step S46: YES), the image display device 10 enables the changed setting (step S48). More specifically, the slide show setting information table TB20 in FIG. 9 is changed by the changed setting contents to reflect the change of setting by the user.

Thereafter, the image display device 10 reads the slide show setting information from the slide show setting information table TB20, at the same time, reads the information specifying the temporarily stopped image from the RAM 22, and restarts the slide show from its image data (step S50). In this example, the slide show is restarted from the image B of the image data DATA-B.JPG in the changed setting of “WITHOUT BGM”. Then, the image display device 10 repeats the process from the aforementioned step S16 in FIG. 4.

In contrast, when judging in the aforementioned step S46 that the OK button B12 is not pressed (step S46: NO), the image display device 10 judges whether the cancel button B14 is pressed (step S52). When the cancel button B14 is pressed (step S52: YES), the image display device 10 restarts the slide show from the temporarily stopped image data without changing the setting (step S50). Then, the image display device 10 repeats the process from the aforementioned step S16 in FIG. 4. Namely, since step S48 is not executed, the slide show setting information of the slide show setting information table TB20 is not changed. Then, the image display device 10 reads the slide show setting information of the slide show setting information table TB20, at the same time, reads the information specifying the temporarily stopped image from the RAM 22, and restarts the slide show from its image data. Therefore, the slide show is restarted from the temporarily stopped image with the setting of the slide show being unchanged.

On the other hand, when judging in step S52 that the cancel button B14 is not pressed (step S52: NO), the image display device 10 repeats the process from step S46.

As described above, according to the image display device 10 of this embodiment, it is possible to temporarily stop the slide show at some mid point and restart the slide show again from the temporarily stopped image after the setting of the slide show is changed. Therefore, the user can watch images to the last without losing interest in the images.

### Second Embodiment

In the aforementioned first embodiment, the slide show setting information is stored in the slide show setting information table B20 in the RAM 22. Hence, the setting of the slide show once made remains effective until the image display device 10 is powered off. Namely, the setting of the slide show performed while the slide show is temporarily stopped is effective even when the slide show ends and another slide show starts. In contrast, in the second embodiment, slide show setting information is held for each slide show, and when the same slide show is reproduced, the slide show is executed in the same setting as the last time. Only points different from the aforementioned first embodiment will be described below.

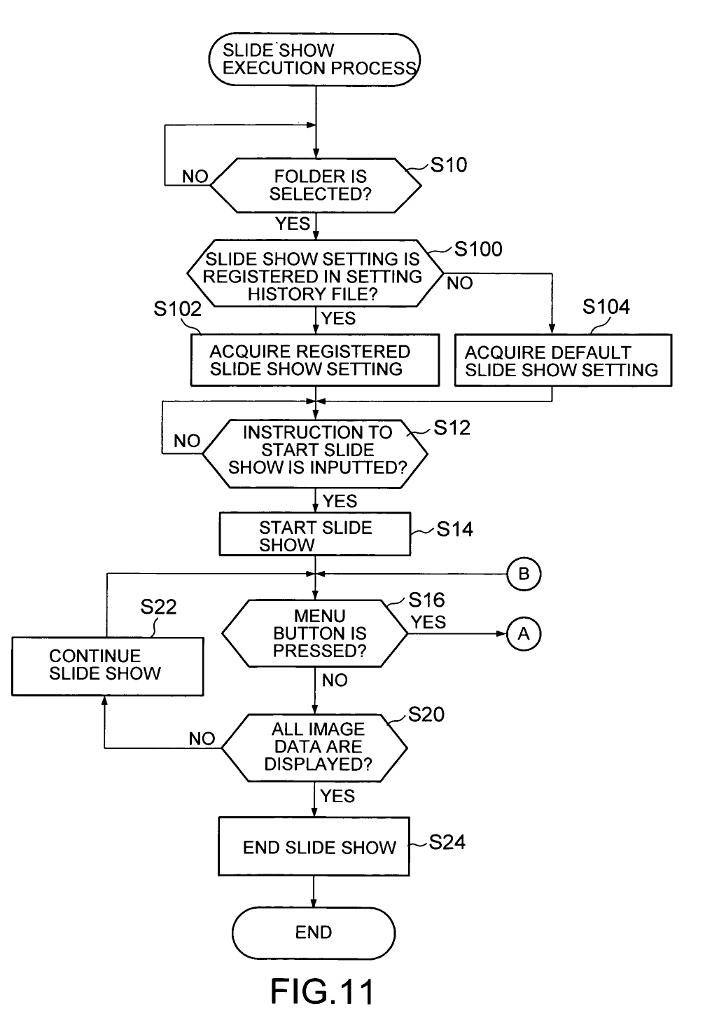

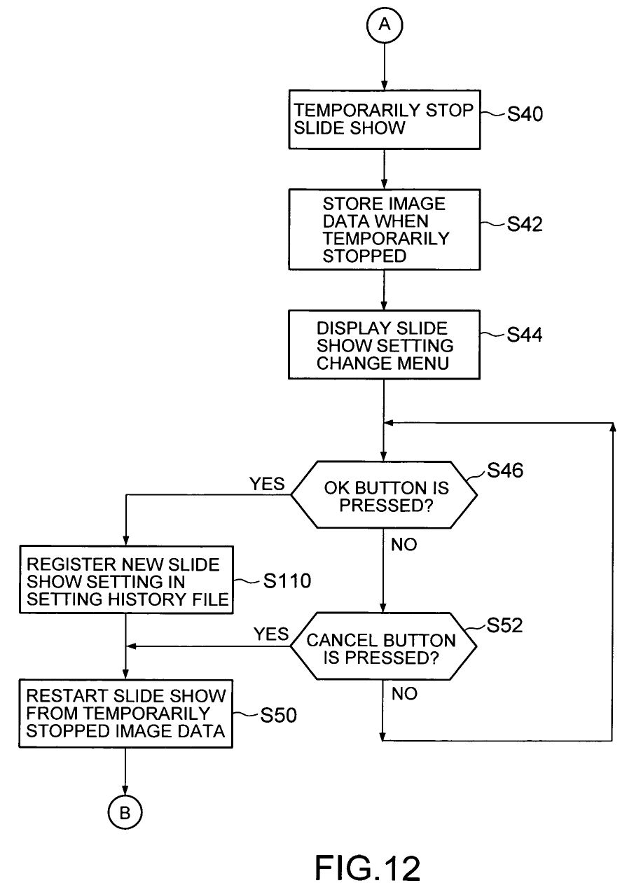

FIG. 11 and FIG. 12 are flowcharts describing a slide show execution process executed by the image display device 10 according to this embodiment, and correspond to FIG. 4 and FIG. 5 in the aforementioned first embodiment.

In this embodiment, when the folder in which the image data to be displayed in the slide show are stored is selected by the user (step S10: YES), the image display device 10 judges whether the slide show setting information on the folder is registered in a setting history file (step S100).

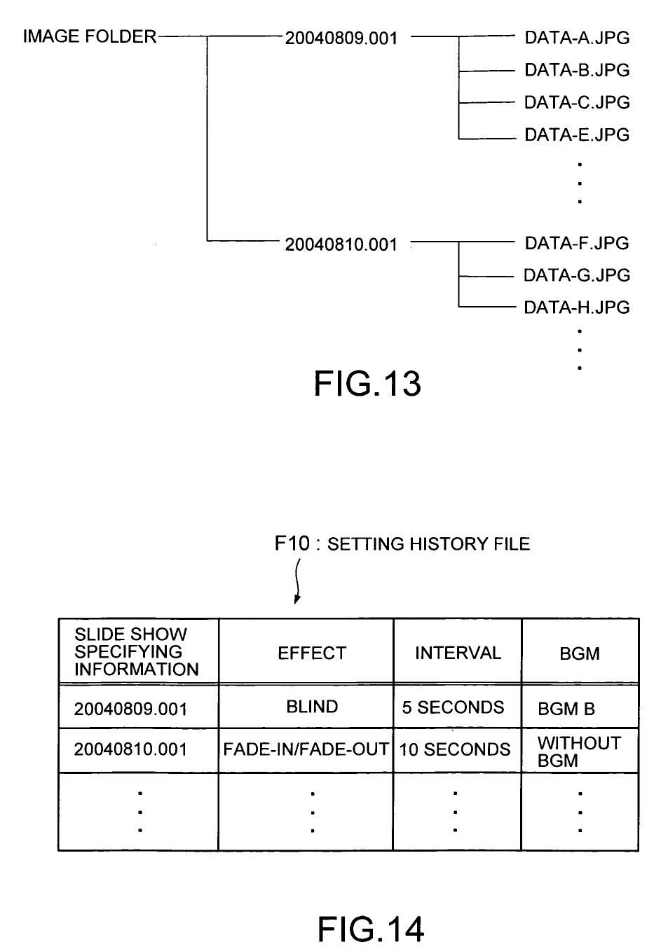

In this embodiment, for example, it is assumed that in the hard disk drive 24, a folder structure such as shown in FIG. 13 is formed to store image data. A setting history file F10 such as shown in FIG. 14 is stored in the hard disk drive 24.

Namely, in this embodiment, the setting history file F10 includes, as data items, slide show specifying information, effect, interval, and BGM. The slide show specifying information is information to specify the slide show, and in this embodiment, the folder name is held as this slide show specifying information. This is because in this embodiment, the slide show is executed on a folder-by-folder basis, whereby the folder name can be used as the slide show specifying information. It is noted, however, that the slide show may be specified in methods other than this or the correspondence between a slide show and image data to be displayed in the slide show may be specified.

Corresponding to this slide show specifying information, the effect, interval, and BGM are stored as slide show setting information set by the user. Hence, in step S100, the image display device 10 searches the setting history file F10 and judges whether the same folder name as the folder name selected by the user is stored in the setting history file F10.

When judging in step S100 that the slide show setting information on the folder selected by the user is registered in the setting history file F10 (step S100: YES), the image display device 10 acquires this slide show setting information (step S102). For example, if the user selects the folder “20040809.001” as a folder whose slide show is to be executed, in FIG. 14, a record in which the slide show specifying information is “20040809.001” is detected, “BLIND” is acquired as the effect, “5 SECONDS” is acquired as the interval, and “BGM B” is acquired as the BGM.

On the other hand, when judging in step S100 that the slide show setting information on the folder selected by the user is not registered in the setting history file F10 (step S100: NO), the image display device 10 acquires the default slide show setting information stored in the ROM 40 (step S104).

The process from step S12 to step S24 after these steps S102 and S104 is the same as that in the aforementioned first embodiment.

When it is judged in step S16 that the menu button is pressed (step S16: YES), the process shown in FIG. 12 is performed. Also in FIG. 12, the process from step S42 to step S52 is the same as the process in the aforementioned first embodiment.

However, it is judged in step S46 that the OK button is pressed (step S46: YES), new slide show setting information set by the user is registered in the setting history file F10 (step S110). Namely, the effect, interval, and BGM set by the user are stored in the setting history file F10 in association with their folder name. When the folder name of the slide show which is being executed at present already exists in the setting history file F10, the new slide show setting information set by the user is overwritten on the existing slide show setting information, and when the folder name of the slide show which is being executed at present does not exist in the setting history file F10, the slide show setting information set by the user is newly registered in the setting history file F10. As is known from the above, only the folder name in which some change is added to the default slide show setting by the user is registered in the setting history file F10.

After step S110, the information specifying the temporarily stopped image is read from the RAM 22 and the slide show is restarted in the slide show setting set by the user (step S50).

As described above, also according to the image display device 10 of this embodiment, it is possible to temporarily stop the slide show at some mid point and restart the slide show again from the temporarily stopped image after the setting of the slide show is changed. Therefore, the user can watch images to the last without losing interest in the images.

Moreover, the slide show setting information is stored and held for each slide show, whereby in the same setting of the slide show as the preceding setting thereof performed by the user, the user can also enjoy the slide show thereafter. In other words, the user can register different slide show setting information on each slide show and execute the slide show.

### Third Embodiment

Although only one slide show setting can be registered for one slide show in the aforementioned second embodiment, in the third embodiment, one or plural slide show settings can be registered for one slide show, and the user can select any one slide show setting from registered slide show settings. Only points different from the aforementioned second embodiment will be described below.

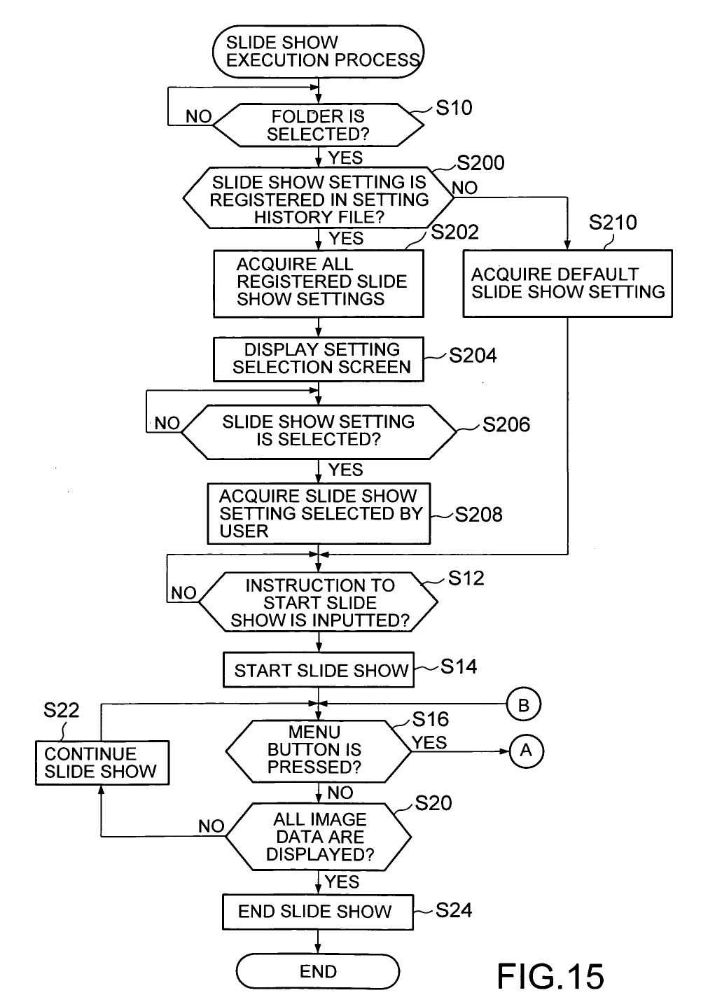

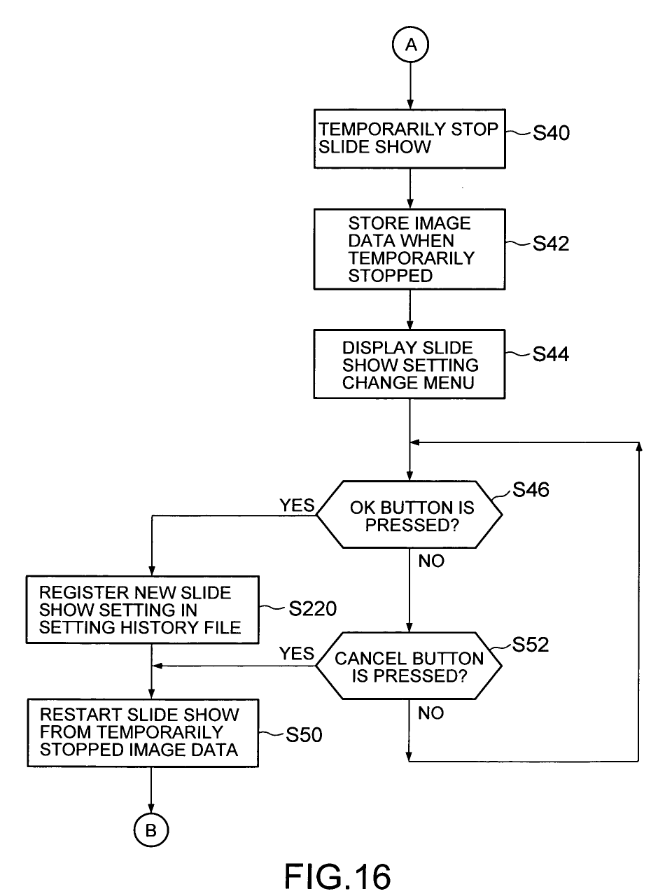

FIG. 15 and FIG. 16 are flowcharts describing a slide show execution process executed by the image display device 10 according to this embodiment, and correspond to FIG. 11 and FIG. 12 in the aforementioned second embodiment.

As shown in FIG. 15, in this embodiment, when, in step S10, the folder in which the image data to be displayed in the slide show are stored is selected by the user (step S10: YES), the image display device 10 judges whether at least one piece of slide show setting information corresponding to the folder is registered in the setting history file (step S200).

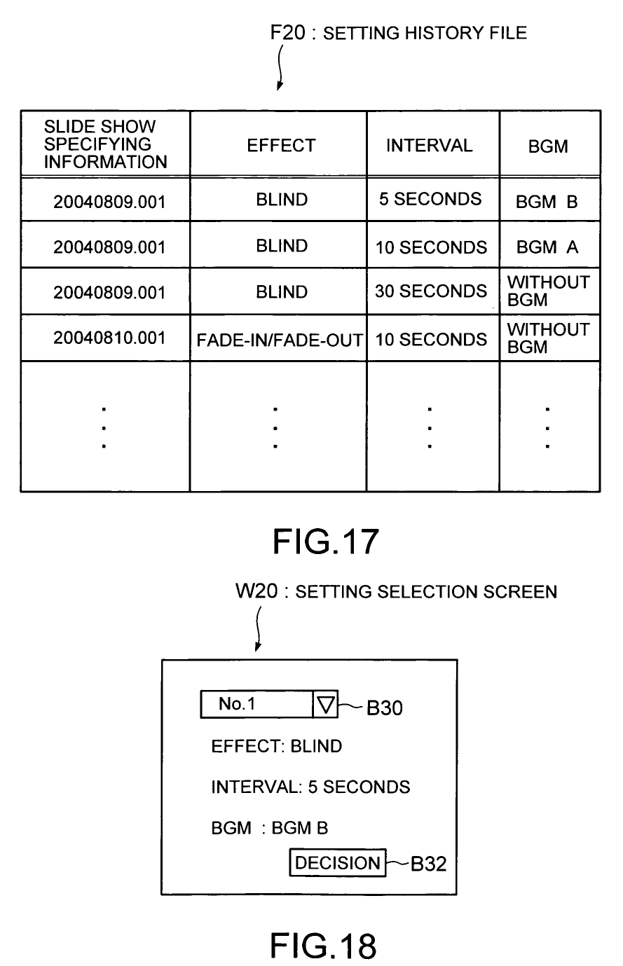

In this embodiment, for example, it is assumed that in the aforementioned folder structure shown in FIG. 13, the user selects the folder “20040809.001” in step S10. If it is assumed that a setting history file F20 such as shown in FIG. 17 is stored in the hard disk drive 24, the image display device 10 searches slide show specifying information of the setting history file F20 and judges whether at least one folder “20040809.001”, which is selected by the user, is registered in the setting history file F20.

When at least one folder selected by the user is registered in the setting history file F20 (step S200: YES), the image display device 10 acquires all slide show settings of the folder selected by the user which are registered in the setting history file F20 (step S202). In the aforementioned example shown in FIG. 17, since three pieces of slide show setting information are held in association with the folder “20040809.001”, the image display device 10 acquires these three pieces of slide show setting information.

Then, the image display device 10 displays a setting selection screen on the display screen 54 (step S204). FIG. 18 is a diagram showing an example of a setting selection screen W20 displayed on the display screen 54. As shown in FIG. 18, if the user operates a selection button B30, slide show setting information on a selected slide show which is held in the setting history file F20 is displayed in sequence. In this example, since three pieces of slide show setting information are held, the three pieces of slide show setting information of No. 1, No. 2, and No. 3 are displayed in sequence every time the user clicks the button B30. The user selects one piece of slide show setting information by clicking a decision button B32 when his or her favorite slide show setting information is displayed on the setting selection screen W20.

Hence, in step S206, the image display device 10 judges whether the user selects one slide show setting and clicks the decision button B32, and when the decision button B32 is not clicked (step S206: No), the image display device 10 stands by while repeating the process in step S206.

On the other hand, when judging that the decision button B32 is clicked (step S206: YES), the image display device 10 acquires the slide show setting information selected by the user (step S208). For example, when the user selects the No. 1 slide show setting information, the image display device 10 acquires “BLIND” as the effect, “5 SECONDS” as the interval, and “BGM B” as the BGM.

In contrast, when judging in the aforementioned step S200 that the folder selected by the user is not registered in the setting history file F20 (step S200: NO), the image display device 10 acquires the default slide show setting information stored in the ROM 40 (step S210).

The process from step S12 to step S24 after these steps S208 and step S210 is the same as that in the aforementioned first embodiment. Namely, the slide show of the folder selected by the user is executed in the slide show setting selected by the user, or the slide show of the folder selected by the user is executed in the slide show setting set by default.

When it is judged in step S16 that the menu button is pressed (step S16: YES), the process shown in FIG. 16 is performed. Also in FIG. 16, the process from step S40 to step S52 is the same as that in the aforementioned first embodiment.

However, it is judged in step S46 that the OK button is pressed (step S46: YES), new slide show setting performed by the user is additionally registered in the setting history file F20 (step S220). Namely, the effect, interval, and BGM set by the user are additionally stored in the setting history file F20 in association with their folder name.

As compared to the aforementioned second embodiment, the second embodiment and this embodiment differ in the following point: in the second embodiment, when the slide show setting information on the slide show which is being executed at present already exists in the setting history file F10, the new slide show setting is overwritten on this existing slide show setting information, but in this embodiment, the new slide show setting is additionally stored in the setting history file F20. Therefore, the slide show setting hitherto registered by the user is held as it is in the setting history file F20.

After step S220, the information specifying the temporarily stopped image is read from the RAM 22 and the slide show is restarted in the slide show setting set by the user (step S50).

As described above, also according to the image display device 10 of this embodiment, it is possible to temporarily stop the slide show at some mid point and restart the slide show again from the temporarily stopped image after the setting of the slide show is changed. Therefore, the user can watch images to the last without losing interest in the images.

Moreover, plural pieces of slide show setting information can be stored and held for each slide show, and the user can select one from the held plural pieces of slide show setting information and execute it, whereby regarding the folder the slide show of which is to be executed by the user, the user can select the most appropriate information from slide show setting information hitherto registered and execute it.

It should be mentioned that the present invention is not limited to the aforementioned embodiments, and various changes may be made therein. For example, in the aforementioned embodiments, the setting on the slide show is changed when the slide show is temporarily stopped, but the present invention is applicable to a case where processes other than the above are performed. For example, after the setting of brightness of the display screen 54, the setting of a power saving mode, or the like is performed, the slide show may be restarted from the temporarily stopped image.

Moreover, in the aforementioned embodiments, the change of the slide show setting information in the case where the slide show is temporarily stopped is explained, but a case where the slide show setting information can be changed after the slide show display is started or the slide show display is ended is also possible. In this case, the changed slide show setting information needs to be stored in the slide show setting information table TB20 in the first embodiment, stored in the setting history file F10 in the second embodiment, and stored in the setting history file F20 in the third embodiment.

As concerns the slide show execution process explained in the aforementioned embodiments, it is possible to record a program to execute this process on a recording medium such as a flexible disk, a CD-ROM (Compact Disc-Read Only Memory), a ROM, a memory card, or the like and distribute this program in the form of the recording medium. In this case, the aforementioned embodiments can be realized by making the image display device 10 read and execute the program recorded on the recording medium.

Furthermore, the image display device 10 sometimes has other programs such as an operating system, other application programs, and the like. In this case, to utilize these other programs in the image display device 10, a program including a command, which calls a program to realize a process equal to that in the aforementioned embodiments out of programs in the image display device 10, may be recorded on the recording medium.

Moreover, such a program can be distributed not in the form of the recording medium but in the form of a carrier wave via a network. The program transmitted in the form of the carrier wave over the network is incorporated in the image display device 10, and the aforementioned embodiments can be realized by executing this program.

Further, when being recorded on the recording medium or transmitted as the carrier wave over the network, the program is sometimes encrypted or compressed. In this case, the image display device 10 which has read the program from the recording medium or the carrier wave needs to execute the program after decrypting or expanding the program.

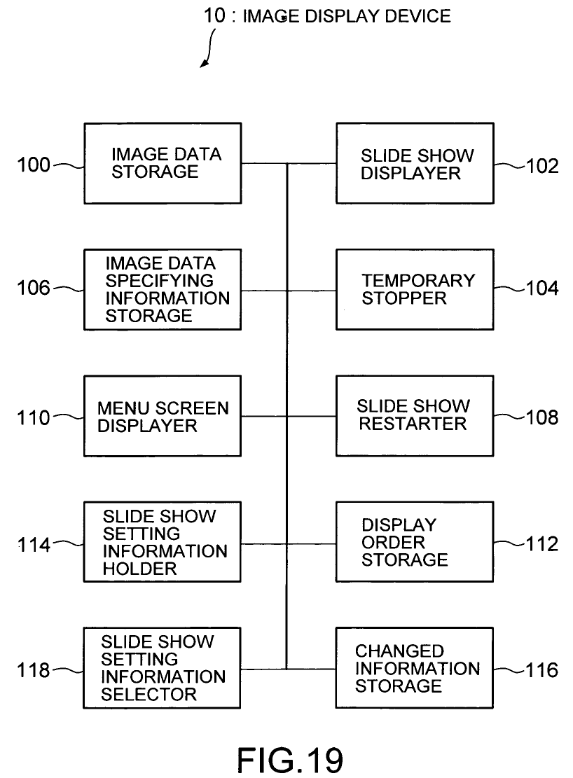

Moreover, the slide show execution process is implemented not only by the software, but also by the hardware. FIG. 19 shows an example of the internal configuration of the image display device in a case where the slide show execution process is implemented by the hardware such as ASIC (Application Specific IC).

As shown in FIG. 19, when the slide show is implemented by the hardware, the image display device 10 further includes an image data storage 100, a slide show displayer 102, a temporary stopper 104, an image data specifying information storage 106 and a slide show restarter 108 in addition to the configuration units in FIG. 1. Further, the image display device 10 optionally includes a menu screen displayer 110, a display order storage 112, a slide show setting information holder 114, a changed information storage 116 and a slide show setting information selector 118.

Plural image data are stored in the image data storage 100. For example, the image data storage 100 is the hard disk drive 24 mentioned above. The slide show displayer 102 performs a slide show display in which the image data are sequentially read from the image data storage 100 and the image data are continuously displayed according to previously set slide show setting information. For example, the image data are displayed on the display screen 54.

The temporary stopper 104 temporarily stops the slide show display of the image data by the slide show displayer based on an instruction from a user. In the embodiments mentioned above, the user instructs the image display device 10 to temporarily stop the slide show display of the slide show displayer 102 by pressing the menu button B10.

The image data specifying information storage 106 stores image data specifying information which specifies image data displayed when the slide show display of the image data is temporarily stopped by the temporary stopper 104. In the embodiments mentioned above, the image data specifying information is stored in the RAM 22.

The slide show restarter 108 reads the image data specifying information from the image data specifying information storage 106 and restarts the slide show display from the image data specified by the image data specifying information.

The menu screen displayer 110 may display a menu screen to allow the user to change a setting of the slide show setting information after the temporary stopper 104 temporarily stops the slide show display. For example, the menu screen displayer 110 displays the menu screen as shown in FIG. 10 on the display screen 54.

When the user changes the slide show setting information based on the menu screen displayed by the menu screen displayer 110, the slide show restarter 108 may restart the slide show display according to the changed slide show setting information.

The display order storage 112 may store an order in which the image data are displayed in the slide show display. In the display order storage 112, image date being displayed now and image data displayed next are held in a one-to-one correspondence. In the embodiments mentioned above, the order of displaying the image data is stored as the display order table TB10 in the RAM 22.

The slide show setting information holder 114 may hold the slide show setting information. When the user changes the slide show setting information based on the menu screen displayed by the menu screen displayer 110, the changed information storage 116 may store the changed slide show setting information in the slide show setting information holder 114 in association with a slide show.

In this case, the slide show setting information holder 114 may hold one piece of slide show setting information in association with one slide show.

Or, the slide show setting information holder may 114 hold one or plural pieces of slide show setting information in association with one slide show.

The slide show setting information selector 118 may allow the user to select one piece of slide show setting information from the slide show setting information held in the slide show setting information holder 114 for the slide show display to be performed before the slide show displayer 102 starts the slide show display.

The structure and process other than this explanation are the same as the embodiments mentioned above.

What is claimed is:

1. An image display device, comprising:
an image data storage in which plural image data are stored;
a slide show displayer which performs a slide show display in which the image data are sequentially read from the image data storage and the image data are continuously displayed according to previously set slide show setting information;
a temporary stopper which temporarily stops the slide show display of the image data by the slide show displayer based on an instruction from a user;
an image data specifying information storage which stores image data specifying information which specifies image data displayed when the slide show display of the image data is temporarily stopped by the temporary stopper; and
a slide show restarter which reads the image data specifying information from the image data specifying information storage and restarts the slide show display from the image data specified by the image data specifying information.

2. The image display device according to claim 1, further comprising a menu screen displayer which displays a menu screen to allow the user to change a setting of the slide show setting information after the temporary stopper temporarily stops the slide show display.

3. The image display device according to claim 2, wherein, when the user changes the slide show setting information based on the menu screen displayed by the menu screen displayer, the slide show restarter restarts the slide show display according to the changed slide show setting information.

4. The image display device according to claim 1, further comprising a display order storage which stores an order in which the image data are displayed in the slide show display, wherein image date being displayed now and image data displayed next are held in a one-to-one correspondence in the display order storage.

5. The image display device according to claim 1, wherein the slide show setting information includes information about setting a time interval at which switching between images is performed.

6. The image display device according to claim 1, wherein the slide show setting information includes information about setting by what display method the switching between images is performed.

7. The image display device according to claim 1, wherein the slide show setting information includes information about a setting on BGM played during the slide show display.

8. The image display device according to claim 3, further comprising:
a slide show setting information holder which holds the slide show setting information; and
a changed information storage which, when the user changes the slide show setting information based on the menu screen displayed by the menu screen displayer, stores the changed slide show setting information in the slide show setting information holder in association with a slide show.

9. A control method of an image display device including an image data storage in which plural image data are stored, comprising the steps of:
performing a slide show display in which the image data are sequentially read from the image data storage and the image data are continuously displayed according to previously set slide show setting information;
temporarily stopping the slide show display based on an instruction from a user;
storing image data specifying information which specifies image data displayed when the slide show display is temporarily stopped; and
restarting the slide show display from the image data specified by the stored image data specifying information.

10. The control method of the image display according to claim 9, further comprising the step of displaying a menu screen to allow the user to change a setting of the slide show setting information after the slide show display is temporarily stopped.

11. The control method of the image display device according to claim 10, wherein, when the user changes the slide show setting information based on the displayed menu screen, the slide show display is restarted according to the changed slide show setting information in the step of the restarting the slide show display.

12. The control method of the image display device according to claim 9, further comprising the step of storing order information in a display order storage, the order information including an order of displaying the image data in the slide show display, wherein image date being displayed now and image data displayed next are held in a one-to-one correspondence in the display order storage.

13. The control method of the image display device according to claim 9, wherein the slide show setting information includes information about setting a time interval at which switching between images is performed.

14. The control method of the image display device according to claim 9, wherein the slide show setting information includes information about setting by what display method the switching between images is performed.

15. The control method of the image display device according to claim 9, wherein the slide show setting information includes information about a setting on BGM played during the slide show display.

16. The control method of the image display device according to claim 11, further comprising the step of, when the user changes the slide show setting information based on the displayed menu screen, storing the changed slide show setting information in a slide show setting information holder in association with a slide show.

17. The control method of the image display device according to claim 16, wherein the slide show setting information holder holds one piece of slide show setting information in association with one slide show.

18. The control method of the image display device according to claim 16, wherein the slide show setting information holder holds one or plural pieces of slide show setting information in association with one slide show.

19. The control method of the image display device according to claim 18, further comprising the step of allowing the user to select one piece of slide show setting information from the slide show setting information held in the slide show setting information holder for the slide show display to be performed before the slide show display is started.

20. A recording medium, comprising a program to control an image display device including an image data storage in which plural image data are stored, the program being recorded on the recording medium, wherein the program causes the image display device to execute the steps of:
performing a slide show display in which the image data are sequentially read from the image data storage and the image data are continuously displayed according to previously set slide show setting information;
temporarily stopping the slide show display based on an instruction from a user;
storing image data specifying information which specifies image data displayed when the slide show display is temporarily stopped; and
restarting the slide show display from the image data specified by the stored image data specifying information.
